(19) United States
(12) Patent Application Publication
(10) Pub. No.: US 2011/0139907 A1
(43) Pub. Date: Jun. 16, 2011

(54) Tank-cleaning nozzle

(76) Inventors: Hansjoerg Lutz, Reutlingen (DE); Matthias Schneider, Ostfildern (DE)

(21) Appl. No.: 12/928,461

(22) Filed: Dec. 10, 2010

(30) Foreign Application Priority Data
Dec. 11, 2009 (DE) 10 2009 059 038.2

(51) Int. Cl. B05B 1/08; B05B 1/02

(52) U.S. Cl. 239/589.1

(57) ABSTRACT

A tank-cleaning nozzle having an inlet tube, a cleaning head mounted for rotation on the inlet tube and at least one spray nozzle disposed on the cleaning head. The spray nozzle is in the form of a fluidic oscillator nozzle producing an oscillation solid jet at an outlet from the nozzle.

### FIELD OF THE INVENTION

The invention relates to a tank-cleaning nozzle comprising an inlet tube, a cleaning head mounted for rotation on the inlet tube, and at least one spray nozzle disposed on the cleaning head.

### BACKGROUND OF THE INVENTION

This application claims the priority of the German patent application No. 10 2009 059 038.2. The whole disclosure of this prior application is herewith incorporated by reference into this application.

A tank-cleaning nozzle comprising a cleaning head mounted for rotation on the inlet tube is disclosed in the European unexamined patent application EP 1 136 133 A2. In this case, the cleaning head is caused to rotate by the energy of the fluid being sprayed, and it comprises a plurality of spray nozzles, each of which produces a fan-shaped spray jet. The spray nozzles are arranged such that the fan-shaped spray jets collectively form a fan-shaped jet that extends through 180° starting from an axis of rotation so that the entire interior surface of the tank can be cleaned.

It is an object of the present invention to provide an improved tank-cleaning nozzle.

### SUMMARY OF THE INVENTION

To this end, the invention provides a tank-cleaning nozzle which comprises an inlet tube, a cleaning head mounted for rotation on the inlet tube, and at least one spray nozzle disposed on the cleaning head, in which tank-cleaning nozzle the spray nozzle is in the form of a fluidic oscillator nozzle producing an oscillating solid jet.

A fluidic oscillator nozzle does not contain any moving components for producing the oscillating solid jet. Rather, the discharged jet is deflected periodically due to the periodic generation of negative/positive pressures inside the spray nozzle so that it appears to be a discharged oscillating solid jet but is in reality composed of large individually discharged drops that collectively produce a wave movement with an increasing amplitude in the direction extending away from the outlet orifice. The very great advantage of such a fluidic oscillator nozzle consists in the production of a solid jet that can generate a much higher impact force and thus achieve a greatly enhanced cleaning efficiency as compared with the distribution of droplets in a fan-shaped spray showing a constant rate of flow. Surprisingly, the tank-cleaning nozzle of the invention can be of a simple design that is less susceptible to breakdown due to the fact that no moving components are required for producing the oscillating solid jet. Fluidic oscillator nozzles of various designs are known and periodically varying flow conditions can be produced within the spray nozzle for the purpose of producing an oscillating solid jet, for example, by means of a special configuration of fluid chambers in the interior of the nozzle. The frequency of oscillation of the solid jet and the rotational speed of the cleaning head can be adjusted to match each other. Such an adjustment is often not necessary since the nozzle oscillates very rapidly and thus acts almost as a fan that simultaneously covers the entire width so that a rapid and thorough cleaning process can be performed by the tank-cleaning nozzle of the invention. It is possible to provide a plurality of such fluidic oscillator nozzles on the cleaning head in order to make it possible to achieve a desired coverage area by means of such a plurality of oscillating solid jets. The cleaning head can be driven in a manner known per se by means of the energy of the introduced fluid being sprayed. The introduced cleaning fluid has a pressure between 1 bar and 10 bar. Such pressure range gives excellent results when cleaning the interior of a tank with the inventive tank-cleaning nozzle.

In a development of the invention, the fluidic oscillator nozzle produces a plane fan spray by means of the oscillating solid jet.

The term “plane fan spray” is understood to mean that the solid jet is deflected in substantially one plane only. Since the fluidic oscillator nozzle is disposed on the rotating cleaning head, a surface surrounding the tank-cleaning nozzle can thus be totally cleaned. A plurality of fluidic oscillator nozzles can be disposed on the cleaning head in order to collectively produce a fan spray of 180°. For the purposes of the invention, the term “fan spray” is understood to mean merely the surface that is covered by the oscillating solid jet after a defined period of time. The fluidic oscillator nozzles used in the tank-cleaning nozzle of the invention always produce an oscillating solid jet which, depending on the distance it travels through the air before impinging on a surface to be cleaned, is substantially in the form of a solid jet when it impinges on the surface to be cleaned and thus ensures thorough cleaning of said surface. The oscillating solid jet, when moving at a high frequency, is perceived as a fan spray by the human eye.

In a development of the invention, the fluidic oscillator nozzle comprises an inlet chamber, into which the fluid to be sprayed enters, and an outlet chamber comprising an outlet orifice, a throat being formed at the transition between the inlet chamber and the outlet chamber. Advantageously, a feedback duct is provided that leads from the outlet chamber and returns to the same.

The provision of a feedback duct makes it possible to generate reliably recurring periodic changes in the conditions of flow in the outlet chamber. The fluid discharged from the inlet chamber is accelerated when passing through the throat present at the transition between the inlet chamber and the outlet chamber such that a negative pressure is produced. The length of the feedback duct is then configured, for example, such that the resonance frequency of the feedback duct is approximately equal to the desired oscillation frequency of the solid jet discharged. At the two regions where the feedback duct ends at the outlet chamber, a negative or a positive pressure is thus generated periodically that then results in a periodic deflection of the solid jet discharged from the outlet orifice.

In a development of the invention, the feedback duct leads directly from the outlet chamber and returns thereto in the region of the throat between the inlet chamber and the outlet chamber. Advantageously, the feedback duct at least partially surrounds the inlet chamber.

In this way, a compact design of the fluidic oscillator nozzle can be achieved, and a plurality of fluidic oscillator nozzles can be accommodated in a compact cleaning head of a tank-cleaning nozzle of the invention.

In a development of the invention, the cleaning head can be driven by means of the fluid being sprayed.

This totally obviates any necessity for the provision of external driving means of any kind and achieves a particularly simple design and operation of the tank-cleaning nozzle of the invention.

### BRIEF DESCRIPTION OF THE DRAWINGS

Additional features and advantages of the invention are revealed in the following description of a preferred embodiment of the invention with reference to the drawings, in which:

FIG. 1 is a diagrammatic illustration of a tank-cleaning nozzle of the invention,

FIG. 2a is a diagrammatic sectional view of a fluidic oscillator nozzle pertinent to the tank-cleaning nozzle shown in FIG. 1,

FIG. 2b is a front view of the fluidic oscillator nozzle of FIG. 2a ,

FIG. 3 is a sectional, partly diagrammatized view of a tank-cleaning nozzle according to a first embodiment,

FIG. 4 is a schematical view from above onto a tank-cleaning nozzle according to a second embodiment,

FIG. 5 is a perspective view of a nozzle unit for a tank-cleaning nozzle according to a third embodiment,

FIG. 6 is a front view of the nozzle unit of FIG. 5,

FIG. 7 is a view onto the sectional plane A-A in FIG. 6,

FIG. 8 is a side view of the nozzle unit of FIG. 5,

FIG. 9 is a view onto the sectional plane B-B in FIG. 8,

FIG. 10 is a perspective view of a nozzle plate of the nozzle unit of FIG. 5,

FIG. 11 is a front view of the nozzle plate of FIG. 10, and

FIG. 12 is a side view of the nozzle plate of FIG. 10.

### DETAILED DESCRIPTION

The diagrammatic illustration in FIG. 1 shows a tank-cleaning nozzle 10 of the invention, which comprises an inlet tube 12 for the supply of fluid to be sprayed, usually water, and a cleaning head 14 mounted for rotation on the inlet tube 12. The cleaning head 14 is disposed on the inlet tube 12 so as to be able to rotate about the central longitudinal axis 16 of the tank-cleaning nozzle 10, as indicated by the arrow 18. The cleaning head 14 is driven by the introduced fluid in a manner that is known per se. This can be brought about by the provision of a swirl insert in the interior of the cleaning head 14, which swirl insert then causes the fluid inside the cleaning head 14 to rotate and thus entrain the cleaning head 14 itself. Alternatively or additionally, it is also possible, for example, to align the spray nozzles on the cleaning head 14 such that the recoil of the nozzles produced by the discharged fluid causes rotation of the cleaning head 14.

A total of three fluidic oscillator nozzles 20, 22, and 24 are provided on the cleaning head 14. These fluidic oscillator nozzles 20, 22, 24 are formed within a planar plate-like body and each produce oscillating solid jets each denoted by a dashed line. The dashed line is naturally merely a diagrammatic representation of an oscillating solid jet. The advantage of the oscillating solid jet is that it sweeps over a surface to be cleaned in the form of a solid jet and thus produces a spray pattern indicated by the two solid lines 26. The spray pattern produced thus merely represents an area within which the solid jet produced oscillates. By contrast, conventional spray nozzles produce a fan-shaped spray jet that does not alter its shape over time and has a distribution of droplets that is constant with time.

It is evident from the illustration in FIG. 1 that the spray patterns produced by the fluidic oscillator nozzles 20, 22 and 24 overlap such that an angular range of about 180° is covered. Since the cleaning head 14 rotates about the central longitudinal axis 16, the tank-cleaning nozzle 10, when inserted into the tank through an opening, can clean the entire interior surface of such a tank. The total spray pattern produced by the fluid oscillator nozzles 20, 22, 24 extends from the central longitudinal axis 16 through 180° back to the central longitudinal axis 16.

The illustration in FIG. 2a is a diagrammatic sectional view of the fluidic oscillator nozzle 20 shown in FIG. 1. The fluidic oscillator nozzle 20 comprises an inlet chamber 28, into which the fluid to be sprayed enters through a nozzle inlet port 30. The inlet chamber 28 then comprises a throat 34 in the transition region leading to an outlet chamber 32. On leaving the inlet chamber 28, the fluid is accelerated by the throat 34, and a negative pressure is generated directly downstream of the throat 34.

In the transition region between the inlet chamber 28 and the outlet chamber 32 and thus directly downstream of the throat 34, a feedback duct 36 leads from the outlet chamber and returns to the same. The feedback duct 36 thus surrounds the inlet chamber 28 and the inlet port 30. In the region where the feedback duct 36 opens into the outlet chamber 32, the feedback duct 36 expands and merges with the outlet chamber 32.

The outlet chamber 32 is approximately bone-shaped and comprises a first section 38, into which the fluid jet discharged through the throat 34 enters and from which the feedback duct 36 starts and at which the feedback duct 36 also ends.

A cross-sectional constriction 40 is provided in the outlet chamber downstream of the first section, and the outlet chamber 32 then expands again downstream of the cross-sectional constriction 40 to assume approximately the shape of a circle in a second section 42.

An outlet orifice 44 is disposed downstream of the second section 42 of the outlet chamber 32, from which an oscillating solid jet is then discharged during the operation of the fluidic oscillator nozzle 20.

During the operation of the fluidic oscillator nozzle 20, a fluid jet enters the first section 38 of the outlet chamber 32 by way of the throat 34. A negative pressure is then generated on each side of the fluid jet, and the fluid is fed back via the feedback duct 36 to each of the mutually opposing sides of the fluid jet. The feedback duct creates pressure conditions on both sides of the fluid jet entering the first section 38 of the outlet chamber 32, which pressure conditions change periodically at a constant frequency and then ultimately result in the production of a solid jet downstream of the outlet orifice 44, which solid jet oscillates periodically in the sectional plane of FIG. 2.

As is evident from the drawings, the fluidic oscillator nozzle 20 has no moving components whatsoever and is for this reason less susceptible to contamination and wear. Furthermore, the free cross-sections can be such that they are large enough to allow small particles in the fluid being sprayed, usually water, to pass through without clogging the fluidic oscillator nozzle 20.

FIG. 2b shows a front view of the fluidic oscillator nozzle 20 of FIG. 2. A housing 21 of the nozzle 20 consists of a base plate 23 and a cover plate 25. The outlet orifice 44 has a rectangular shape. Together with the dish-like flat shape of the outlet chamber 32 the shape of the outlet orifice 44 causes a plane fan spray which extends parallel to the cover plate 21 and the base plate 25 of the housing 21.

FIG. 3 shows a partly sectional, partly diagrammatical view of an inventive tank-cleaning nozzle 50 forming a cleaning head 14A according to a first preferred embodiment of the invention. The tank-cleaning nozzle 50 has a gear unit 52 and a nozzle unit 54, the nozzle unit 54 having three fluidic oscillator nozzles 56, 58 and 60. The spray pattern of each of the fluidic oscillator nozzles 56, 58 and 60 is indicated in FIG. 3 with broken lines. The nozzle unit 54 is rotated in the clockwise direction by means of the gear unit 52. The gear unit 52 causes a rotational movement of the nozzle unit 54 by means of the energy of the liquid to be sprayed.

To this end, the gear unit 52 comprises a two-part housing 62, the housing 62 being fixedly connected to an inlet tube which is not shown in FIG. 3 but can be seen in FIG. 1. Inside the housing, a fan wheel 64 is mounted for rotational movement on a first shaft 66. The fan wheel 64 is mounted below two inflow ducts 68, which guide inflowing liquid onto the fan wheel 64. The fan wheel 64 is only diagrammatically shown but is caused to rotate in the clockwise direction as soon as liquid exits the inflow ducts 68 and impinges onto the fan wheel 64.

The shaft 66 is on its lower part below the fan wheel 64 provided with a gear tooth. The gear tooth of the shaft 66 engages with a first gear wheel 70, which is accommodated in the housing 62 and which is fixedly connected to a second shaft 72. The second shaft 72 is opposite the first gear wheel 70 provided with a second gear wheel 74, which meshes with an inner gear tooth on a rotor 76. The rotor 76 extends through an opening in the lower end of the housing 62 and is connected to the nozzle unit 54.

When liquid to be sprayed enters into the housing 62 and exits through the inflow ducts 68, it impinges onto the fan wheel 64 and causes a rotational movement of the fan wheel 64. This rotational movement causes the first gear wheel 70 and consequently the second gear wheel 74 to rotate. The second gear wheel 74 drives the rotor 76 which then causes the fluidic oscillator nozzles 56, 58, 60 on the nozzle unit 54 to rotate in the clockwise direction. The rotational movement of the fan wheel 64 is reduced in speed by the gear drive formed by means of the gear tooth on the shaft 66, the first gear wheel 70, the second gear wheel 74 and the inner gear tooth on the rotor 76.

The liquid to be sprayed passes through the housing 62 and enters into the nozzle unit 54, flows to the fluidic oscillator nozzles 56, 58, 60 and exits the nozzle unit 54 as a fan-shaped spray jet at each of the fluidic oscillator nozzles 56, 58, 60. A pressure of the liquid to be sprayed between 1 bar and 10 bar has shown to have an excellent cleaning effect when sprayed by means of the fluidic oscillator nozzles 56, 58 and 60.

FIG. 4 shows a diagrammatical view from above onto a tank-cleaning nozzle 80 according to a second embodiment of the invention. The tank-cleaning nozzle 80 has a rotor 82 which is mounted for rotational movement onto a fixed inlet tube 84.

The housing 82 is rotationally driven by the recoil of the fluidic oscillator nozzles 86, 88. As can be seen in FIG. 4, the fluidic oscillator nozzles 86, 88 are offset by approximately 5° from radially extending plane 90. This offset is sufficient to cause a rotational movement in the anti-clockwise direction of the housing 82 when fluid exits the fluidic oscillator nozzles 86, 88 in the form of a flat fan spray pattern which is indicated by arrows 92, 94 in FIG. 4. The fluid to be sprayed has a pressure in the range of 1 bar to 10 bar which is sufficient to cause a rotational movement of the housing 82 and also provides an excellent cleaning result on the interior of a tank.

FIG. 5 shows a perspective view of a nozzle unit 100 forming a cleaning head 14B according to a third embodiment of the invention. The nozzle unit 100 can be fixed to the gear unit 50 in FIG. 3 and will then rotate in the clockwise direction around the axis 102. The nozzle unit 100 has ten fluidic oscillator nozzles 104, 105, 106, 107, 108, 109, 110, 111, 112, 113 and 114. Nozzles 112 and 114 as well as nozzles 105, 107, 111 and 113 cannot be seen in FIG. 5.

With respect to an orthogonal axis 116, which is perpendicular to the axis 102, the axes of the outlets from the nozzles 104, 106 and 108 are spaced from each other by an angle of approximately 35°. The axes of the outlets from the nozzles 110, 112 and 114 are also spaced from each other with respect to the axis 116 by an angle of 35° each.

The nozzle unit 100 comprises two nozzle blocks 118, 120, the first nozzle block 118 and the second nozzle block 120 being spaced from each other by an angle of 90° with respect to the axis 116. Each of the nozzles 104 to 114 produces a plane fan spray of 60° each. Nozzles 104, 106 and 108 to 110, 112 and 114 together cover, therefore, an angle of approximately 180°. Nozzles 105, 107 and 111 and 113 are provided for additional cleaning and for balancing, the nozzle unit 100 during spraying, i.e. to better compensate the recoil of the nozzles 104, 106, 108 and 110, 112, 114 respectively. Since the nozzle unit 100 is rotated about the axis 102, the complete interior of a tank can be cleaned with fluid emerging from the nozzles 104 to 114.

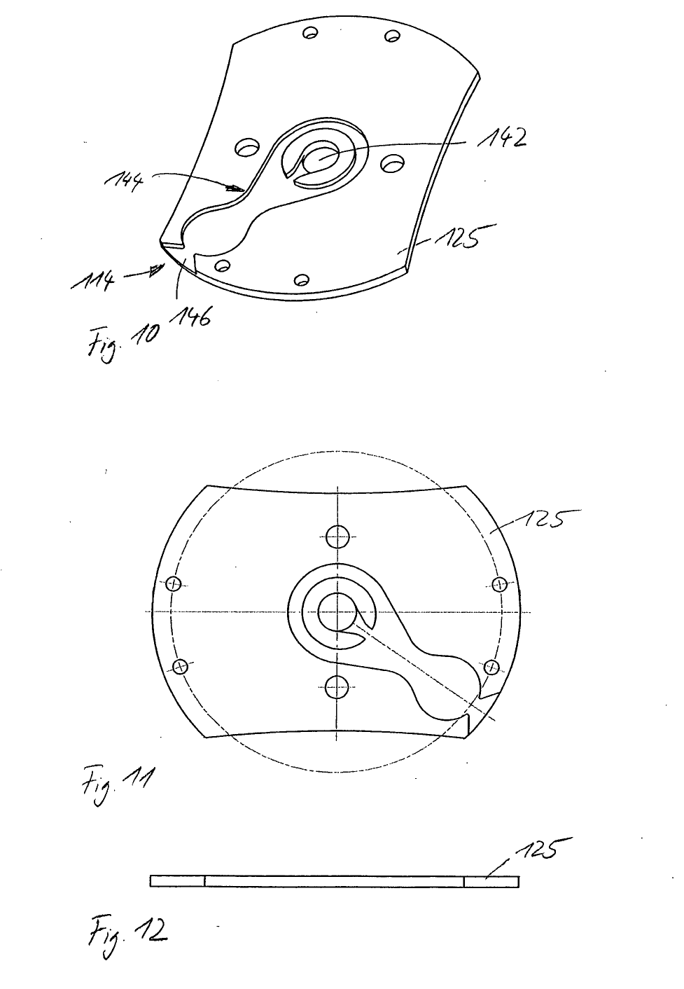

Each of the nozzle blocks 118, 120 comprises seven planar plates 122 to 128 which are all arranged perpendicular to the axis 116. Five of these plates, namely the plates 123, 124, 125, 126 and 127 are formed as nozzle plates each containing a cavity and an outlet opening to form a fluidic oscillator nozzle. The nozzle plate 125 is shown in detail in FIGS. 10 to 12. The plate 122 is formed as a cover plate and covers the nozzle cavity of nozzle plate 123. The plate 128 is also formed as a cover plate, however, plate 128 has a central through hole to enable fluid to reach the nozzle plates 123 to 127. Nozzle block 118 is identically formed by seven plates as is nozzle block 120.

The plates 122 to 128 are held together by means of screw bolts 130. Screw bolts 132 are screwed into a base 134 of the nozzle unit 100. The base 134 is provided with a tube 136 extending from the base 134 to a gear unit for rotating the nozzle unit 100, such gear unit being shown in FIG. 3. The tube 136 and the base 134 each comprise fluid channels for a guiding fluid to be sprayed to the fluidic oscillator nozzles 104 to 114.

FIG. 6 shows a side view of the nozzle unit 100 of FIG. 5.

The plates 122 to 128 each have a circular shape with two segments of circle being cut away on opposite sides of the circular form.

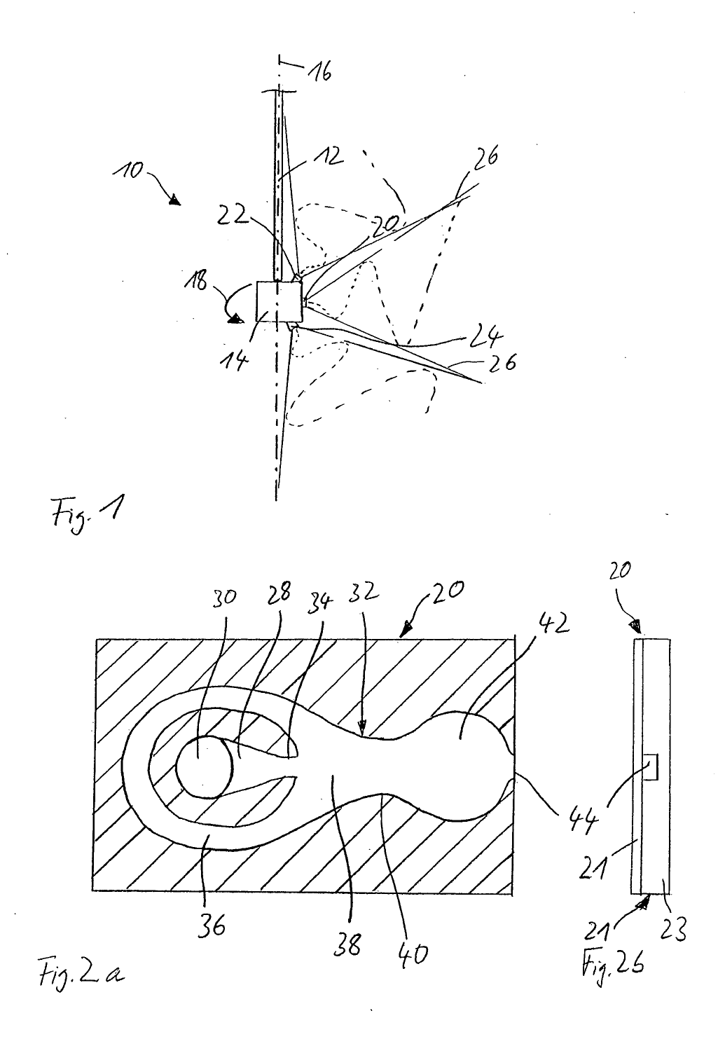

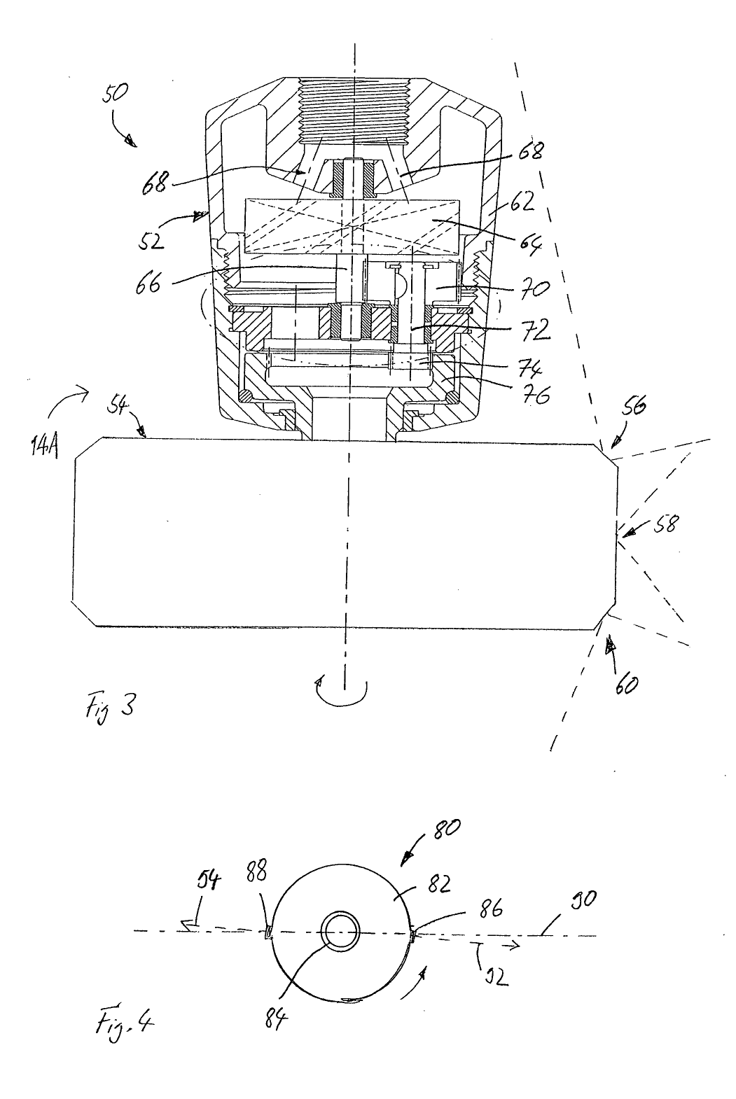

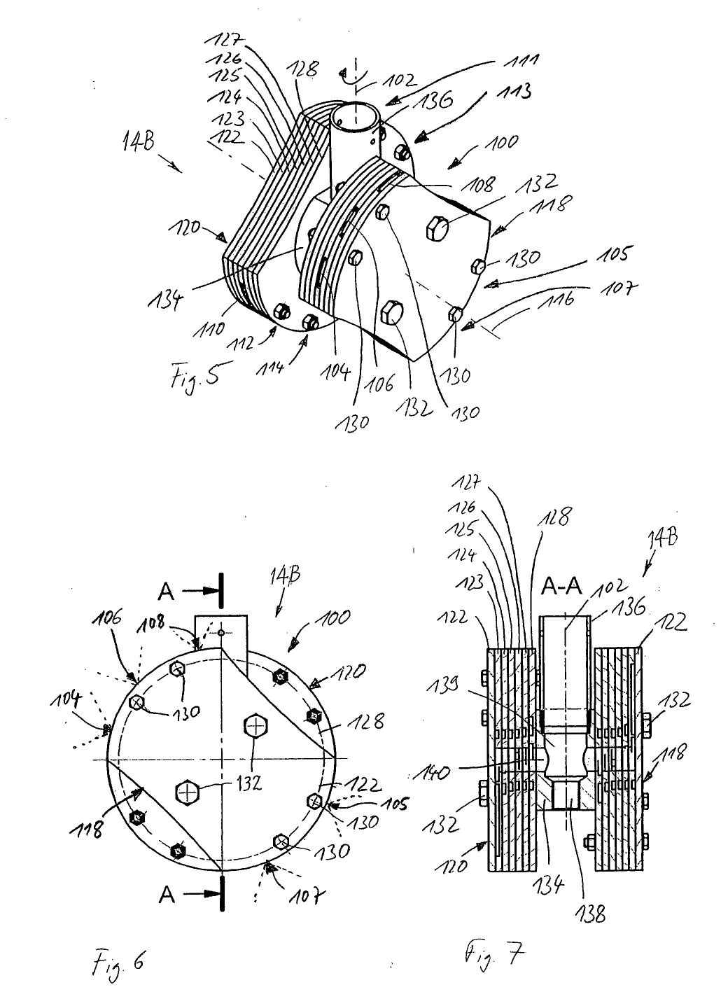

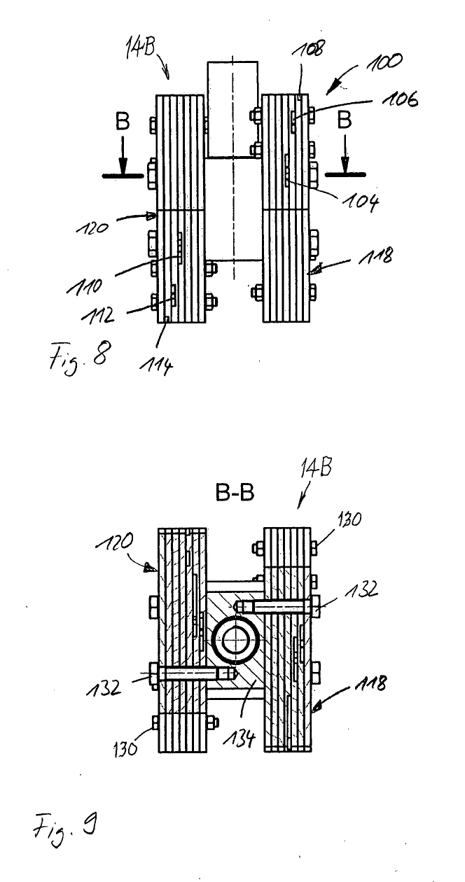

FIG. 7 shows a view onto sectional plane A-A of FIG. 6. The base 134 has a central through bore 139 concentric to the axis 102 which is closed by a screw bolt 138 on its lower end. The central through bore 139 opens to the tube 136. The base 134 further comprises an orthogonal through bore 140 which extends through the base 134 perpendicular to the axis 102 and which intersects the central through bore 139. The through bore 140 provides two fluid channels leading from the base 134 to the nozzle block 118 and 120, respectively.

Each of the plates 123 to 128 has a central through bore, the central through bores of the plates 123 to 128 being aligned with each other and the through bore 140 of the base 134. Thereby, a fluid channel is formed which extends through the nozzle blocks 118 and 120 and which is closed on the radially outer side by the respective cover plates 122.

The plates 122 to 128 of each nozzle block 118 and 120 are held together by means of the screw bolts 130. The nozzle blocks 118 and 120 are then fixed to the base by means of the screw bolts 132.

FIG. 8 shows a side view of the nozzle unit 100 of FIG. 5. The outlet openings of each of the fluidic oscillator nozzles 104, 106, 108 and 110, 112, 114 can be seen in the nozzle blocks 118 and 120, respectively.

FIG. 9 shows a view onto the sectional plane B-B in FIG. 8. The screw bolts 132 extend through the nozzle blocks 118 and 120, respectively and are screwed into blind holes in the base 134 to securely hold the nozzle blocks 118, 120 on the base 134.

FIG. 10 shows a perspective view of nozzle plate 125. Nozzle plate 125 comprises a central through bore 142 and a cavity 144 which defines an outlet chamber 32 of the fluidic oscillator nozzle 114. The cavity 144 is formed as has already been explained in conjunction with FIG. 2a and is, therefore, not explained again.

In contrast to the fluidic oscillator nozzle 20 shown in FIG. 2a, an outlet opening 146 of the fluidic oscillator nozzle 114 has a shape opening up into the outflow direction. The boundaries of this outlet opening enclose an angle of approximately 110° as can also be seen in FIG. 11.

FIG. 11 shows a view from above onto the nozzle plate 125 and FIG. 12 shows a side view of the nozzle plate 125.

The nozzle unit 100 shown in FIGS. 5 to 9 is of modular construction and less or more fluidic oscillator nozzles can be provided without problems. The number of fluidic oscillator nozzles can be adapted to the amount of fluid to be sprayed and to space requirements, respectively. Apart from the number of nozzle plates also different nozzle plates can be used, e.g. for varying the amount of fluid to be sprayed, the oscillating frequency of the generated liquid jet and/or the angle of the generated spray pattern.

The use of an oscillating solid jet for cleaning generates the effect of cleaning with a pulsating jet since one and the same spot on the inner wall of a tank is hit by the oscillating jet in predefined time intervals. The time intervals depend on the frequency of the oscillating solid jet and the rotational frequency of the nozzle. Such a cleaning with a pulsating jet or cleaning with an oscillating solid jet provides excellent cleaning results.

What is claimed is:

1. A tank-cleaning nozzle having an inlet tube, a cleaning head mounted for rotation on said inlet tube and at least one spray nozzle disposed on said cleaning head, wherein said spray nozzle is in the form of a fluidic oscillator nozzle producing an oscillating solid jet.

2. The tank-cleaning nozzle as defined in claim 1, wherein said fluidic oscillator nozzle produces a plane fan spray by means of the oscillating solid jet.

3. The tank-cleaning nozzle as defined in claim 1, wherein said fluidic oscillator nozzle has an inlet chamber into which the fluid to be sprayed enters, and an outlet chamber comprising a discharge orifice, a throat being provided at the transition between said inlet chamber and said outlet chamber.

4. The tank-cleaning nozzle as defined in claim 3, wherein a feedback duct is provided which leads from said outlet chamber and returns thereto and wherein said feedback duct at least partially surrounds said inlet chamber.

5. The tank-cleaning nozzle as defined in claim 4, wherein said feedback duct leads from said outlet chamber and returns to said outlet chamber in the region of said throat between said inlet chamber and said outlet chamber.

6. The tank-cleaning nozzle as defined in claim 1, wherein said cleaning head can be driven by means of said spray liquid.

7. A tank-cleaning nozzle, comprising:
a cleaning head having a nozzle unit with an inlet bore configured to be connected to a source of liquid and a drive means configured to effect a rotation of said cleaning head about an axis of rotation in response to a liquid flow from said source through said inlet bore; and
at least one nozzle mounted on said cleaning head, said nozzle having a nozzle inlet port in said nozzle for supplying liquid from said inlet bore to said nozzle and a nozzle outlet configured to form a liquid jet exiting said nozzle outlet, said nozzle having a series of internal chambers forming a fluidic oscillator section intermediate said nozzle inlet port and said nozzle outlet which is configured for varying a direction of flow of the liquid jet so as to form a planar fan spray pattern extending radially outwardly from said cleaning head.

8. The tank-cleaning nozzle according to claim 7, wherein said drive means includes an orienting of the direction of said nozzle outlet so that it is at an angle to a radius of said cleaning head to generate a torque to facilitate a rotation of said cleaning head driven by the oscillating liquid jet exiting said nozzle outlet.

9. The tank-cleaning nozzle according to claim 7, wherein said drive means is a stationary housing member that includes therein a rotatably supported gear unit connected to said nozzle unit which is rotatable therewith, said gear unit being configured to be driven for rotation in response to liquid moving from a liquid inlet into said stationary housing to said nozzle unit.

10. The tank-cleaning nozzle according to claim 7, wherein a plurality of nozzles are mounted on said cleaning head, each of said nozzles comprising a planar plate-like body and are arranged side-by-side, each nozzle outlet from a respective nozzle being oriented at an angle relative to one other nozzle so that spray angles of said planar fan spray patterns developed thereby are additive to form an increased angle of spray pattern.

11. The tank-cleaning nozzle according to claim 10, wherein said inlet bore extends co-extensively with an axis of rotation of said cleaning head; and wherein a radially extending bore connects to said inlet bore and supplies liquid to a nozzle inlet port on each of said plurality of said nozzles.

12. The tank-cleaning nozzle according to claim 11, wherein said drive means includes an orienting of the direction of said plurality of said nozzle outlets so that they are at an angle to a radius of said cleaning head to generate a torque to facilitate a rotation of said cleaning head driven by the oscillating liquid jets exiting said nozzle outlets.

13. The tank-cleaning nozzle according to claim 11, wherein said planar plate-like bodies extend in planes that are perpendicular to a radius extending radially outwardly from said axis of rotation.

14. The tank-cleaning nozzle according to claim 13, wherein said nozzle inlet ports of each of the plurality of nozzles are axially aligned with an axis of said radially extending bore.

15. The tank-cleaning nozzle according to claim 14, wherein said plurality of nozzles are organized into first and second groups of plural nozzles, said first group of nozzles including first and second sets of nozzle outlets having axes that are arranged 180° from each other, said second group of nozzles including third and fourth sets of nozzle outlets having axes that are arranged 180° from each other.

16. The tank-cleaning nozzle according to claim 15, wherein the number of nozzle outlets in said first set being more than the number of nozzle outlets in said second set and the number of nozzle outlets in said third set being more than the number of nozzle outlets in said fourth set.

17. The tank-cleaning nozzle according to claim 15, wherein said first and second groups of plural nozzles are arranged on diametrically opposite sides of said axis of rotation and include an equal number of nozzles.

18. The tank-cleaning nozzle according to claim 17, wherein said first and second sets of said first group of nozzles each producing a combined planar fan spray pattern organized in side-by-side planes that are parallel to said axis of rotation, the mid arc location of the spray pattern coinciding with a plane containing a radius of said axis of rotation of said cleaning head.

19. The tank-cleaning nozzle according to claim 18, wherein said third and fourth sets of said second group of nozzles each producing a combined planar fan spray pattern organized in side-by-side planes that are parallel to said axis of rotation, the mid arc location of the spray pattern coinciding with a plane containing a radius of said axis of rotation of said cleaning head.
